(19) United States
(12) Patent Application Publication
(10) Pub. No.: US 2007/0213894 A1
(43) Pub. Date: Sep. 13, 2007

(54) Signal Transferring System for Vehicles

(76) Inventor: Christopher Huang, Taichung (TW)

Correspondence Address: BANGER SHIA, 204 CANYON CREEK, VICTORIA, TX, 77901, US

(21) Appl. No.: 11/427,246

(22) Filed: Jun. 28, 2006

(30) Foreign Application Priority Data
Mar. 7, 2006 (TW) 095107625

(51) Int. Cl. G06F 19/00

(52) U.S. Cl. 701/29; 701/1; 340/438

(57) ABSTRACT

A signal transferring system for vehicles, which is mounted between a vehicle ECU (Electronic Control Unit) and a computer testing apparatus, comprising a transferring seat and an accessing carrier, wherein the transferring seat is disposed with a communication signal protocol converter and a signal processor, and the accessing carrier stored with signal processing procedures is mounted on the signal processor of the transferring seat. Therefore, since the accessing carrier stored with signal processing procedures can be inserted into the transferring seat, and signal processing procedures stored by the accessing carrier are corresponded to the vehicle ECU of each different vehicle manufacturers for detecting each driving parameter of the vehicle ECU, thus adjusting the related electronic systems of the vehicles.

### BACKGROUND OF THE INVENTION

1. Field of the Invention

The present invention relates to a signal transferring system for vehicles, and more particularly to a signal transferring system for vehicles mounted between a vehicle ECU (Electronic Control Unit) and a computer testing apparatus to adjust the driving parameter of the vehicles, such as the ignition, the oil-supplying, the air admission, and other related systems of the vehicles.

2. Description of the Prior Art

During driving, the problem of a sudden increasing oil leak may occur. Most drivers would send the vehicles to factories for examination, during which a computer testing apparatus 11 is connected to a vehicle ECU (Electronic Control Unit) 13 via a signal converter 12 to detect each driving parameter of the vehicle ECU 13, thus adjusting the ignition, the oil-supplying and the air admission systems of the vehicle, and recovering the suitable driving parameter of the vehicle ECU 13, as shown in FIG. 1.

Since the vehicle ECU 13 of every manufacturer is different, the signal converters 12 used for connecting the vehicle ECU 13 to the computer testing apparatus 11 are different, too. To reduce costs, factories will not always purchase additionally the computer testing apparatus 11 and signal converters 12 of each brand. Under such a circumstance, factories can only repair vehicles that are manufactured from some particular vehicle manufacturers.

The present invention has arisen to mitigate and/or obviate the afore-described disadvantages.

### SUMMARY OF THE INVENTION

The primary objective of the present invention is to provide a signal transferring system for vehicles which is provided for connecting the vehicle ECU to the computer testing apparatus.

The signal transferring system for vehicles is mounted between a vehicle ECU and a computer testing apparatus, including a transferring seat and an accessing carrier. The transferring seat is disposed with a communication signal protocol converter and a signal processor; and the accessing carrier stored with signal processing procedures is mounted on the signal processor of the transferring seat.

Therefore, the accessing carrier stored with signal processing procedures that can be inserted into the transferring seat, and signal processing procedures stored by the accessing carrier corresponded to the vehicle ECU of each different vehicle manufacturers for detecting each driving parameter of the vehicle ECU, thus adjusting the ignition, the oil-supplying, the air admission, and other related systems of the vehicles.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a block diagram of showing a conventional signal converter connected to a computer testing apparatus and a vehicle ECU;

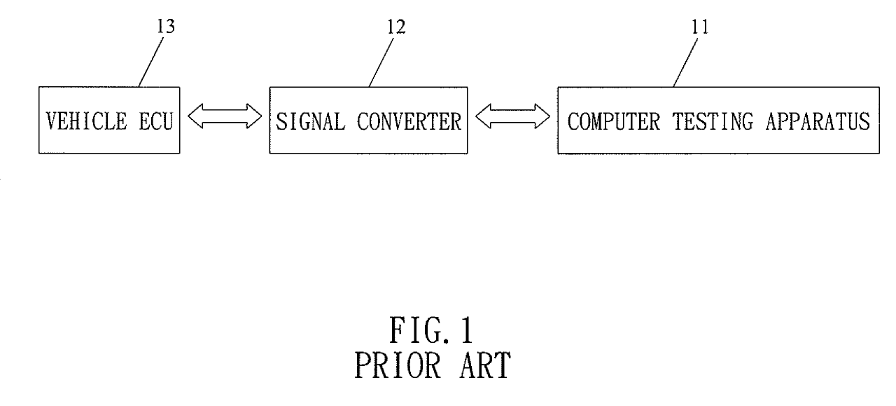

FIG. 2 is a block diagram of showing a signal transferring system for vehicles connected to a computer testing apparatus and a vehicle ECU in accordance with the present invention;

FIG. 3 is a perspective view of showing an accessing carrier stored with signal processing procedures that is inserted into a transferring seat; and

FIG. 4 is the other block diagram of showing a signal transferring system for vehicles in accordance with a second embodiment of the present invention.

### DETAILED DESCRIPTION OF THE PREFERRED EMBODIMENTS

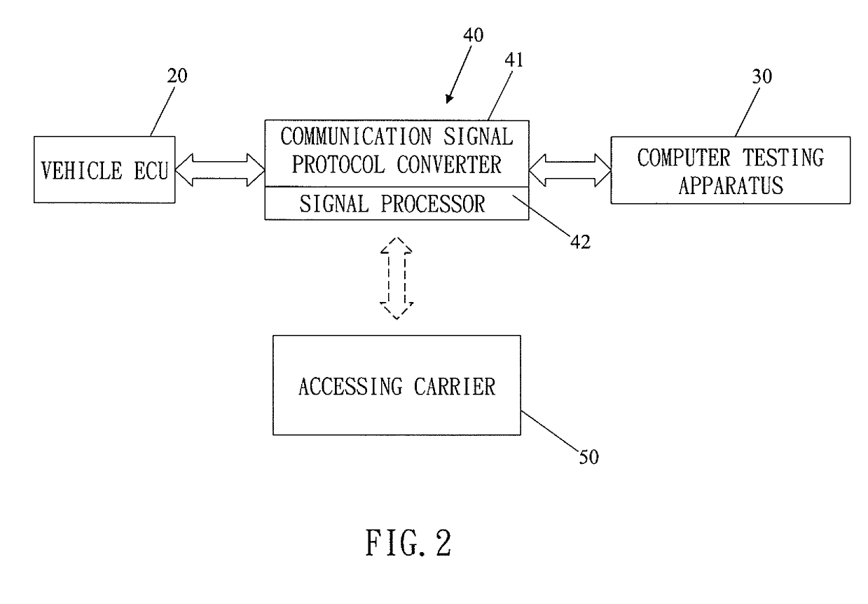

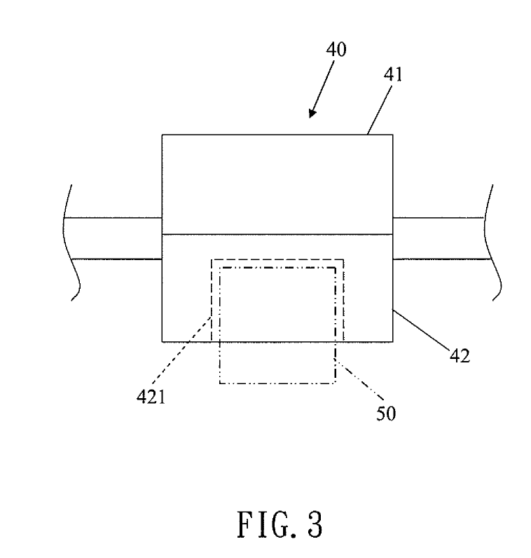

Referring to FIGS. 2 and 3, a signal transferring system for vehicles in accordance with a first embodiment of the present invention is mounted between a vehicle ECU 20 and a computer testing apparatus 30, including a transferring seat 40 and a accessing carrier 50 stored with signal processing procedures, wherein:

The transferring seat 40 is disposed with a communication signal protocol converter 41 and a signal processor 42 that mounted with an inserting groove 421 thereof.

The accessing carrier 50 is inserted into the inserting groove 421 of the transferring seat 40, and connected to the signal processor 42 of the transferring seat 40.

Referring to FIGS. 2 and 3 again, since the transferring seat 40 of the present invention is disposed with the communication signal protocol converter 41 and the signal processor 42, and the accessing carrier 50 stored with signal processing procedures is inserted into the inserting groove 421 of the transferring seat 40, when the signal transferring system for vehicles is mounted between the vehicle ECU 20 and the computer testing apparatus 30, the driving parameter of the vehicle ECU 20 is measured by the signal processor 42, and the signals of the signal processing procedures is obtained by the signal processor 42 by the accessing carrier 50, and transferred to the computer testing apparatus 30 finally by cooperating with the signal conversion of the communication signal protocol converter 41 so as to detect each driving parameter of the vehicle ECU 20, thus adjusting the ignition, the oil-supplying, and the air admission systems of the vehicles.

Therefore, since the accessing carrier 50 stored with signal processing procedures can be inserted into the inserting groove 421 of the transferring seat 40, and signal processing procedures stored by the accessing carrier 50 are corresponded to the vehicle ECU 20 of each different vehicle manufacturers for detecting each driving parameter of the vehicle ECU 20, thus adjusting the ignition, the oil-supplying, and the air admission systems of the vehicles.

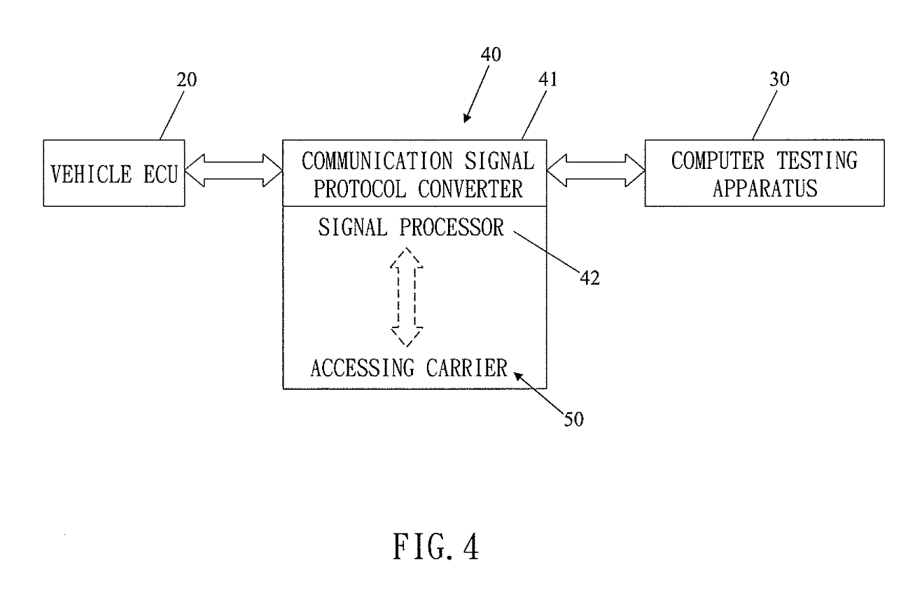

Referring to FIG. 4, a signal transferring system for vehicles in accordance with a second embodiment of the present invention is mounted between a vehicle ECU 20 and a computer testing apparatus 30, including a transferring seat 40 and a accessing carrier 50 stored with signal processing procedures, wherein:

The transferring seat 40 is disposed with a communication signal protocol converter 41 and a signal processor 42.

The accessing carrier 50 stored with signal processing procedures, which is mounted in the transferring seat 40 and connected to the signal processor 42. Since the signals of the signal processing procedures is obtained by the signal processor 42 by the accessing carrier 50, and transferred to the computer testing apparatus 30 by cooperating with the signal conversion of the communication signal protocol converter 41 so as to detect each driving parameter of the vehicle ECU 20.

While we have shown and described various embodiments in accordance with the present invention, it should be clear to those skilled in the art that further embodiments may be made without departing from the scope of the present invention.

What is claimed is:

1. A signal transferring system for vehicles, which is mounted between a vehicle ECU (Electronic Control Unit) and a computer testing apparatus, comprising:
a transferring seat disposed with a communication signal protocol converter and a signal processor; and
an accessing carrier stored with signal processing procedures mounted in the transferring seat and connected to the signal processor of the transferring seat, the signals of the signal processing procedures obtained by the signal processor by the accessing carrier and transferred to the computer testing apparatus finally by cooperating with the signal conversion of the communication signal protocol converter so as to detect each driving parameter of the vehicle ECU.

2. A signal transferring system for vehicles, which is mounted between a vehicle ECU (Electronic Control Unit) and a computer testing apparatus, comprising:
a transferring seat disposed with a communication signal protocol converter and a signal processor mounted with an inserting groove thereof;
an accessing carrier stored with signal processing procedures mounted in the inserting groove of the transferring seat and connected to the signal processor of the transferring seat, the signals of the signal processing procedures obtained by the signal processor by the accessing carrier and transferred to the computer testing apparatus finally by cooperating with the signal conversion of the communication signal protocol converter so as to detect each driving parameter of the vehicle ECU.
